(19) United States
(12) Patent Application Publication
(10) Pub. No.: US 2004/0019547 A1
(43) Pub. Date: Jan. 29, 2004

(54) Sales support information providing method

(75) Inventors: Mitsuyoshi Watanabe, Kawasaki (JP); Takeshi Imamura, Kawasaki (JP); Misako Kawabe, Kawasaki (JP); Yoshito Yui, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/619,605

(22) Filed: Jul. 16, 2003

(30) Foreign Application Priority Data
Jul. 19, 2002 (JP) 2002-210897

(51) Int. Cl. G06F 17/60

(52) U.S. Cl. 705/35

(57) ABSTRACT

In a sales support information providing method, an answer request is transmitted to salesperson terminals, the answer request requesting each terminal to input an answer choice to a selling method contained in the request. Answer data from the terminals are received, the answer data of each terminal containing an answer choice input by one of salespersons for the selling method. The respective answer data corresponding to the salespersons are stored cumulatively as an answer file, the answer file containing records which correspond to the answer data of the salespersons respectively. Each record of the answer file is extracted to increment each of total counts for one or more of predetermined attributes which are met by a corresponding one of the salespersons for the extracted record. Results of the total counts for one or more of the predetermined attributes are transmitted to the salesperson terminals which are related to the selling method.

### BACKGROUND OF THE INVENTION

1. Field of The Invention

The present invention generally relates to a sales support information providing method which provides the information concerning a selling method in a sales company taking the form of selling products or goods at a plurality of shops. More specifically, the present invention relates to a sales support information providing method which is configured to support a plurality of salespersons to share the information about success cases in the method of selling products or goods.

2. Description of the Related Art

Recently, in sales companies which take the form of face-to face selling of products to the customers at the actual shops, attention is given to the problem that the sales are greatly influenced by the salesperson's product knowledge and sales know-how.

For example, the difference appears in sales between a shop the salespersons of which have good sales technique with abundant product knowledge and another shop the salespersons of which have little knowledge and poor sales technique even if the shops sell the same products.

Japanese Laid-Open Patent Application No. 2001-344400 discloses a business information collecting/browsing system as an approach to resolve the above problem. In the business information collecting/browsing system, the server receives the information, such as the consumer's trend, the consumer's intention, the basis of product choice, and the consumer's questions, from the terminals of sales support members of each shop, stores the received information, and transmits the material data which are created by editing the stored information, to the client terminals.

However, the business information collecting/browsing system of Japanese Laid-Open Patent Application No. 2001-344400 is directed to providing the collected information on real time, and the information provided by the system is uniform and does not necessarily suit the situations of the respective shops. For example, the sales campaigns of the individual shops differ depending on the shop locations and the customer properties, and it is inherent that the sales know-how varies for every shop. It is therefore difficult for the above-mentioned system to provide the sales support information that suits the situations of the respective shops.

### SUMMARY OF THE INVENTION

An object of the present invention is to provide a novel and useful sales support information providing method in which the above-described problems are eliminated.

Another object of the present invention is to provide a sales support information providing method that provides each salesperson with information concerning an optimal selling method for the salesperson by analyzing the product selling method based on the salesperson's attributes, the shop locations, and the customer properties.

The above-mentioned objects of the present invention are achieved by a sales support information providing method which provides salespersons with information concerning a selling method by using a server, comprising steps of: transmitting an answer request to salesperson terminals, the answer request requesting each terminal to input an answer choice to the selling method contained in the request; receiving answer data from the terminals, the answer data of each terminal containing an answer choice input by one of the salespersons for the selling method; storing the respective answer data corresponding to the salespersons cumulatively as an answer file, the answer file containing records which correspond to the answer date of the salespersons respectively; extracting each record from the answer file to increment each of total counts for one or more of predetermined attributes which are met by a corresponding one of the salespersons for the extracted record; and transmitting results of the total counts for said one or more of the predetermined attributes to the salesperson terminals which are related to the selling method.

According to the sales support information providing method of the present invention, it is possible to collect the comments of the salespersons on the product selling method and provide each salesperson with the information concerning an optimal selling method for the salesperson.

Moreover, the sales support information providing method of the present invention makes it possible to easily carry out the generation and transmission of a questionnaire for collecting the comments of the salespersons since the questionnaire can be created automatically with a selected one of success cases sent from the salespersons and a set of answer choices.

### BRIEF DESCRIPTION OF THE DRAWINGS

Other objects, features and advantages of the present invention will be apparent from the following detailed description when read in conjunction with the accompanying drawings.

FIG. 1 is a block diagram of a headquarter system in which a sales support information providing method of one preferred embodiment of the present invention is incorporated.

FIG. 2 is a flowchart for explaining operation of the sales support information providing method of the present embodiment.

FIG. 3 is a flowchart for explaining a bulletin board recording process executed by the headquarter system of the present embodiment.

FIG. 4A and FIG. 4B are diagrams showing an initial menu and a bulletin board file of a salesperson terminal respectively.

FIG. 5A and FIG. 5B are diagrams showing a bulletin board screen and a bulletin board recording screen of the salesperson terminal respectively.

FIG. 6 is a diagram showing a bulletin board file recorded in the headquarter system.

FIG. 7 is a flowchart for explaining a questionnaire downloading process executed by the headquarter system of the present embodiment.

FIG. 8A and FIG. 8B are diagrams showing a bulletin board screen and a questionnaire screen of the headquarter system respectively.

FIG. 9A and FIG. 9B are diagrams showing a questionnaire file and an answer collection state screen respectively.

FIG. 10 is a diagram showing an answer file.

FIG. 11 is a flowchart for explaining an answer totaling process executed by the headquarter system of the present embodiment.

FIG. 12 is a diagram showing a salesperson file.

FIG. 13 is a diagram showing a salesperson attribute total count file.

FIG. 14 is a diagram showing a shop file.

FIG. 15 is a diagram showing a shop attribute total count file.

FIG. 16 is a flowchart for explaining an answer downloading process executed by the headquarter system of the present embodiment.

FIG. 17A and FIG. 17B are diagrams showing success-case action instructions screens.

FIG. 18 is a diagram showing a success-case action instructions screen.

FIG. 19 is a diagram showing a sales report screen.

FIG. 20 is a diagram showing a customer trend screen.

### DETAILED DESCRIPTION OF PREFERRED EMBODIMENTS

A description will now be given of preferred embodiments of the present invention with reference to the accompanying drawings.

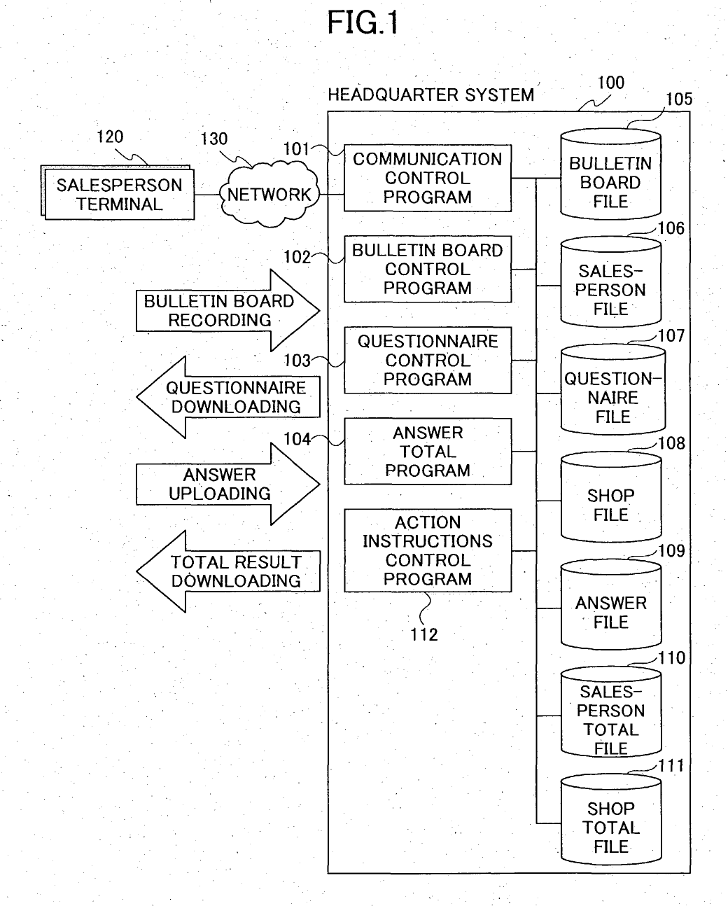

FIG. 1 shows a headquarter system in which a sales support information providing method of one preferred embodiment of the present invention is incorporated.

As shown in FIG. 1, a headquarter system 100 and a plurality of salesperson terminals 120 are interconnected via a network 130. Each of the salesperson terminals 120 may be either a portable terminal which is carried by the salesperson, or a computer which is arranged in the shop which the salesperson belongs to. The network 130 may be either the Internet or the public switched telephone network. Some networks that are capable of transmitting and receiving information electronically between stations may be used.

In the present embodiment, the headquarter system 100 is a computer (a server) which is disposed in the headquarters of a sales company. The headquarter system 100 includes a communication control program 101, a bulletin board control program 102, a questionnaire control program 103, an answer totaling program 104, and an action instructions control program 112. The communication control program 101 causes the computer to carry out a control of communications of the headquarter system 100 with the network 130. The bulletin board control program 102 causes the computer to carry out a control of an electronic bulletin board. The questionnaire control program 103 causes the computer to carry out a control of generation and transmission of a questionnaire. The answer totaling program 104 causes the computer to carry out a control of totaling of answer data received from the salesperson terminals 120. The action instructions control program 112 causes the computer to carry out a control of generation and transmission of action instructions.

The headquarter system 100 is provided with an external storage device (not shown) and an internal storage device (not shown). The above-described programs are stored in the external storage device. When starting execution of each program, the program is read from the external storage device and loaded to the internal storage device.

Moreover, in the external storage device of the headquarter system 100, a bulletin board file 105, a salesperson file 106, a questionnaire file 107, a shop file 108, an answer file 109, a salesperson total file 110, and a shop total file 111 are stored. The bulletin board file 105 contains information concerning the bulletin board. The salesperson file 106 contains information concerning the salespersons. The questionnaire file 107 contains information concerning the questionnaire. The shop file 108 contains information concerning the shops which the salespersons belong to. The answer file 109 contains information concerning answer data in response to the questionnaire. The salesperson total file 110 contains information concerning respective total counts for salesperson attributes. The shop total file 111 contains information concerning respective total counts for shop attributes.

When the necessity arises in the headquarter system 100, the above-described files are accessed or updated by the communication control program 101, the bulletin board control program 102, the questionnaire control program 103, the answer totaling program 104 and the action instructions control program 112.

With the above-described headquarter system 100, the bulletin board recording from the salesperson terminals 120, the downloading of the questionnaire to the salesperson terminals 120, the uploading of the answer data from the salesperson terminals 120, and the downloading of the total result to the salesperson terminals 120 are carried out.

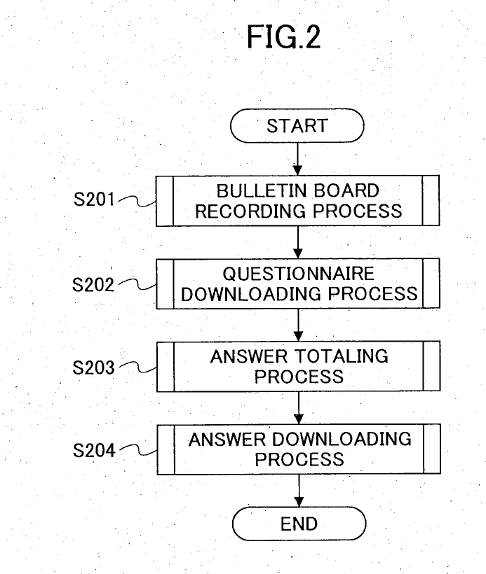

FIG. 2 is a flowchart for explaining operation of the sales support information providing method of the present embodiment.

The headquarter system 100 of the present embodiment is provided with an electronic bulletin board to which the salespersons can freely write data by using the salesperson terminals 120. As shown in FIG. 2, the headquarter system 100 performs a bulletin board recording process (S201). In the bulletin board recording process S201, the salespersons record their success cases concerning the product selling method in the bulletin board of the headquarter system 100.

After the process S201 is performed, the headquarter system 100 performs a questionnaire downloading process (S202). The operator on the headquarter system 100 selects a desired success case from among the success cases which are recorded in the bulletin board during the process S201. The operator causes the headquarter system 100 to generate a questionnaire based on the selected success case, and transmit the questionnaire to the salesperson terminals 120.

After the process S202 is performed, the headquarter system 100 performs an answer totaling process (S203). The headquarter system 100 receives the answer data of the salespersons to the questionnaire (transmitted in the process S202) from the salesperson terminals 120, and performs the answer totaling for one or more of predetermined attributes which are met by a corresponding one of the salespersons for the received answer data.

After the process S203 is performed, the headquarter system 100 performs an answer downloading process (S204). The headquarter system 100 transmits results of the total counts for one or more of the predetermined attributes to the salesperson terminals 120 which are related to the selling method in the questionnaire.

According to the sales support information providing method of the present embodiment, it is possible to collect the answer choices of the respective salespersons on the product selling method and it is possible to provide each related salesperson with the information concerning an optimal selling method for the salesperson. The downloading of the results of the total counts to the salesperson terminals can be suited to the shop location of the salesperson of concern and the customer characteristics.

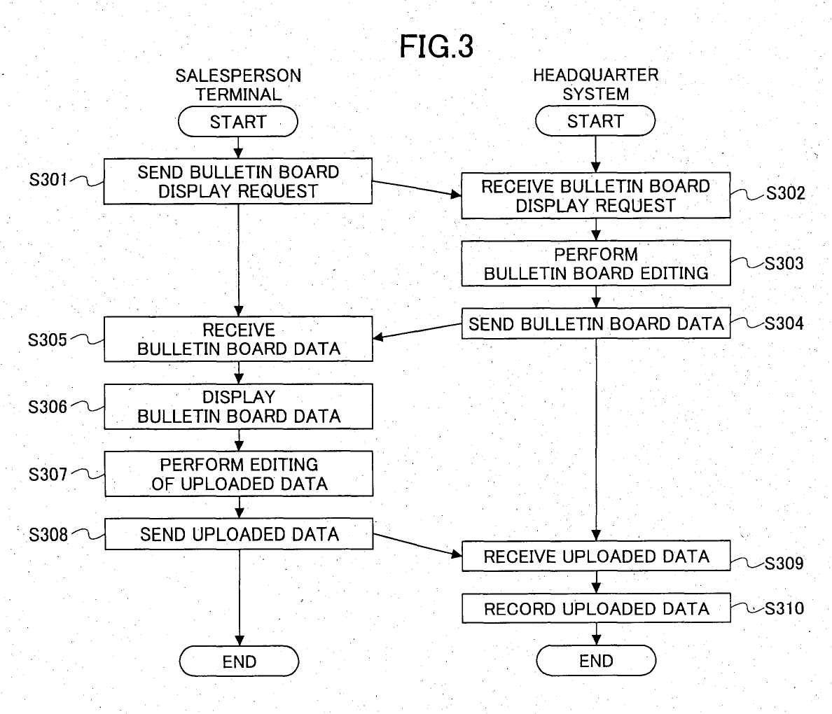

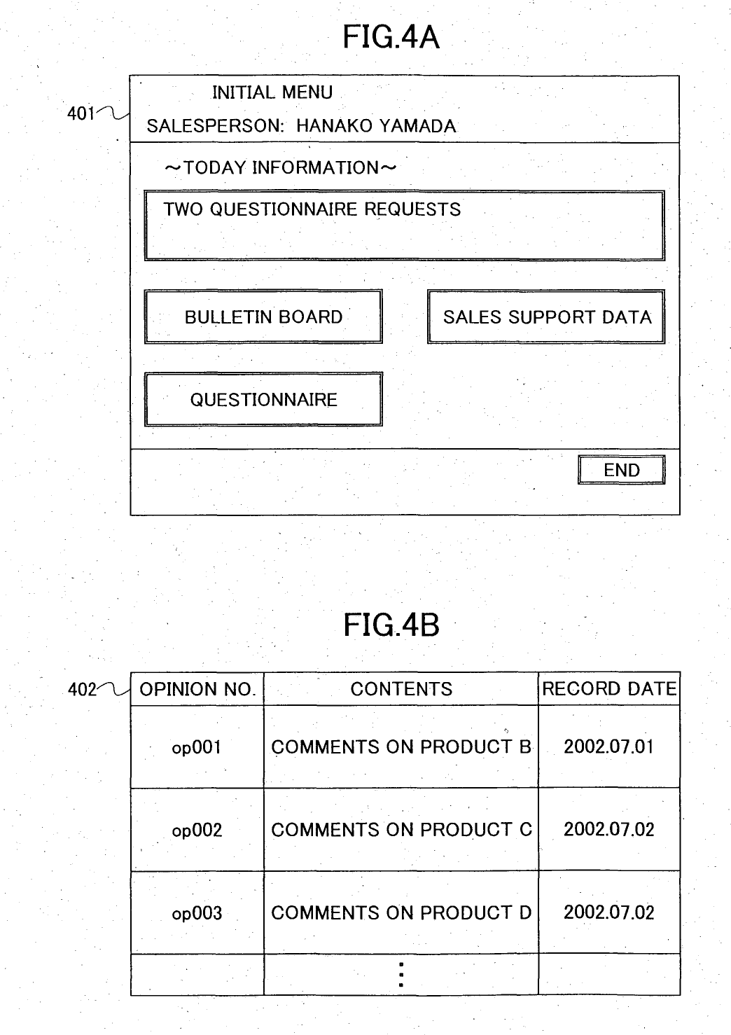

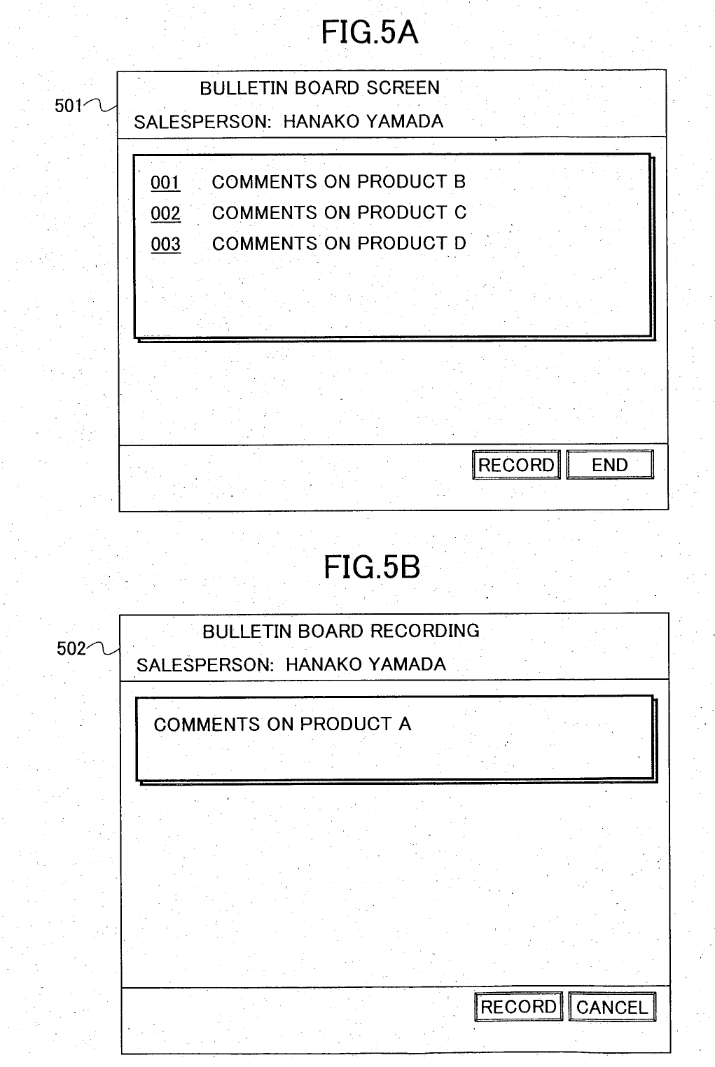

FIG. 3 is a flowchart for explaining the bulletin board recording process S201 executed by the headquarter system 100 of the present embodiment. FIG. 4A and FIG. 4B show an initial menu and a bulletin board file of the salesperson terminal respectively. FIG. 5A and FIG. 5B show a bulletin board screen and a bulletin board recording screen of the salesperson terminal respectively.

A description will now be given of the bulletin board recording process S201 with reference to FIG. 3.

The salesperson terminal 120 is provided with a display unit on which the initial menu of FIG. 4A is displayed. The salesperson clicks the “bulletin board” button of the initial menu on the salesperson terminal 120, which requests the headquarter system 100 to transmit the bulletin board screen being displayed to the salesperson terminal 120 (S301).

The bulletin board display request from the salesperson terminal 120 is sent to the headquarter system 100 via the network 130. The communication control program 101 of the system 100 receives the request from the salesperson terminal 120 (S302).

After the step S302 is performed, the bulletin board control program 102 of the system 100 extracts the recorded comments from the bulletin board file 105, and performs the editing of the bulletin board information to be transmitted (S303).

The bulletin board file 402 of FIG. 4B is illustrated as an example of the bulletin board file 105.

Each record of the bulletin board file 402 is comprised of the comments number for identifying the stored comments uniquely, the contents which are the contents of the comments, and the recording date which shows the recording date.

The bulletin board control program 102 extracts the comments registered into the bulletin board file 105, and edits the bulletin board screen 501 of FIG. 5A.

When the editing in step S303 is completed, the communication control program 101 will transmit the bulletin board screen 501 to the salesperson terminal 120 (S304).

The salesperson terminal 120 receives the bulletin board screen 501 (S305).

The salesperson terminal 1201 will be displayed on display, if the bulletin board screen 501 is received in step S305 (S306).

By this display, the salesperson can check the contents of the electronic bulletin board.

The salesperson clicks the “record” button provided in the footer of the bulletin board screen 501, when registering the success case. The new uploading information is edited by this operation (S307).

When the “record” button is clicked on the bulletin board screen 501, the bulletin board record screen 502 of FIG. 5B will be displayed.

When the input of the success case is completed, the salesperson will click the “record” button provided in the footer of the bulletin board record screen 502, and will transmit this information to the headquarter system 100 (S308).

The communication control program 101 of the headquarter system 100 receives the uploaded data (S309).

The information received in step S309 is registered into the bulletin board file 105 of the headquarter system 100 (S310).

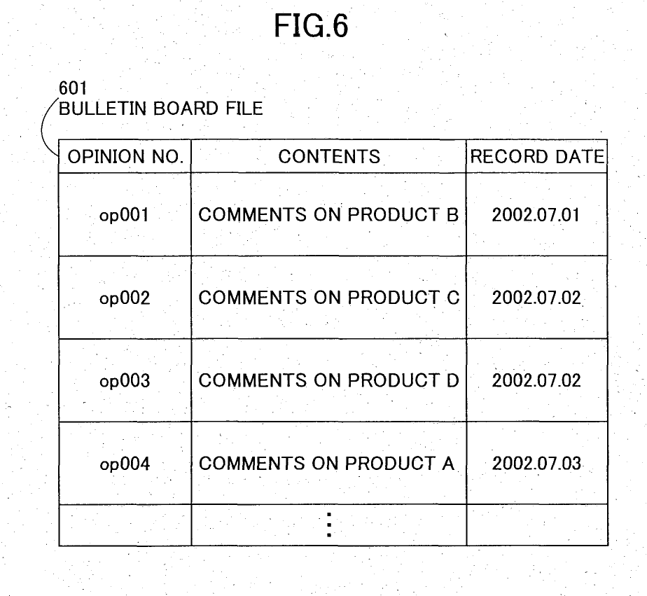

FIG. 6 shows a bulletin board file recorded in the headquarter system. The bulletin board file 601 of FIG. 6 is illustrated as an example of the bulletin board file 105 after the recording.

Thus, the automatic numbering of the comments with the consecutive numbers is carried out, and the recording success case is registered in the form where the recording date is posted from system eyes this time.

Then, if there is the bulletin board display request from the salesperson terminal 120, recording information will be displayed in step S310.

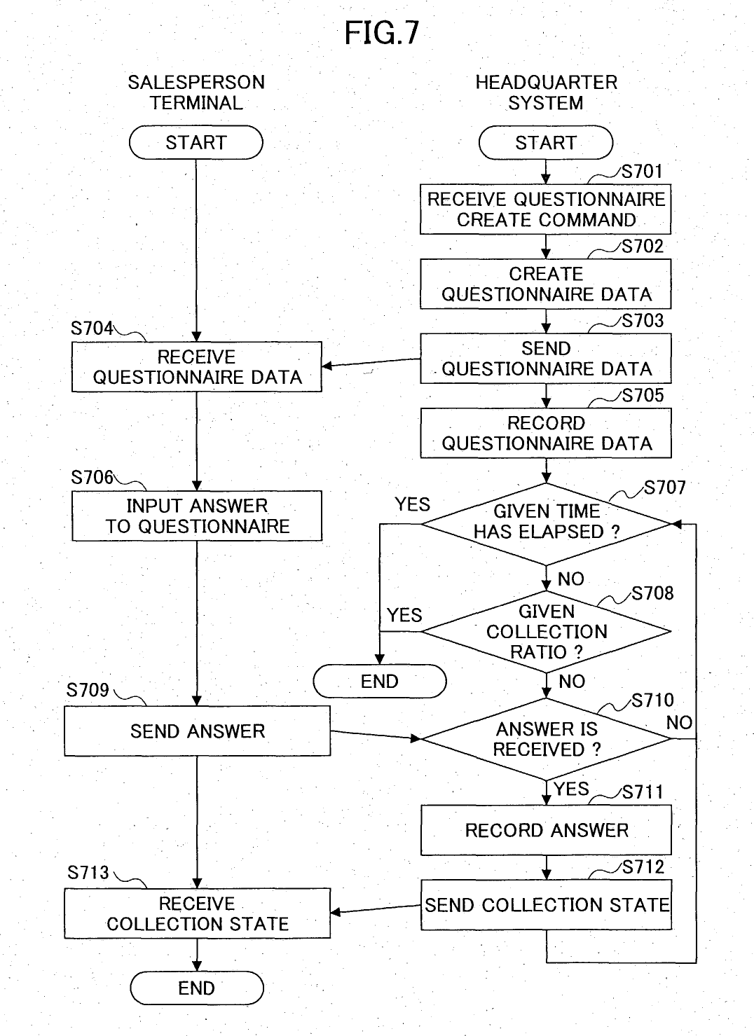

Next, the questionnaire downloading process S202 of FIG. 2 is explained with reference to FIG. 7.

FIG: 7 is a flowchart for explaining the questionnaire downloading process S202 executed by the headquarter system of the present embodiment.

The questionnaire control program 103 of the headquarter system 100 receives the questionnaire create command from the operator of the headquarter system 100 (S701).

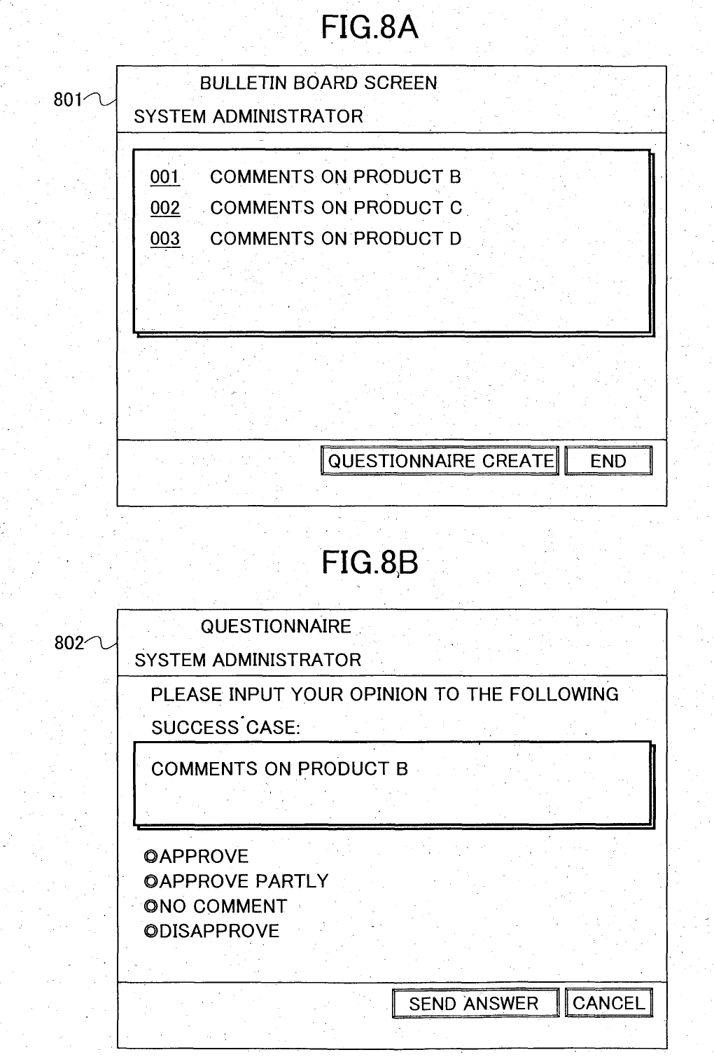

FIG. 8A and FIG. 8B show a bulletin board screen and a questionnaire screen of the headquarter system respectively. The questionnaire create command is executed when the operator operates it from the bulletin board screen 801 of FIG. 8A.

The viewing area which indicates the recording success case by the list is provided in the bulletin board file 105 at the body of the bulletin board screen 801.

The operator of the headquarter system 100 chooses one arbitrary success case from among the recorded success cases indicated by the list, and clicks the “questionnaire creation” button provided in the footer of the bulletin board screen 801.

By this operation, the questionnaire control program 103 receives questionnaire create command.

The questionnaire control program 103 creates the questionnaire based on the success case chosen in step S701, when the questionnaire create command are received in S701 (S702). The questionnaire creation is performed by adding the answer choices for the questionnaire to the information of the success case chosen in step S701.

The questionnaire created in step S702 is displayed on the operator like the questionnaire screen 802 of FIG. 8 B.

The success case comments chosen in step S701 and the four option buttons: “approval”, “approving partly”, “no reaction”, and “disapproval”, which are the answer choices for the questionnaire, are displayed on the body of the questionnaire screen 802. The operator checks the contents displayed on the questionnaire screen 802, and when the contents are satisfactory for the operator, the operator clicks the “send answer” button provided in the footer of the questionnaire screen 802.

The downloading of the questionnaire is requested to the questionnaire control program 103 by the clicking of the button.

The questionnaire control program 103 transmits the questionnaire to the salesperson terminal 120 in response to the above request (S703).

The salesperson terminal 120 receives the questionnaire transmitted in step S703, and displays the same on the display unit (not shown) (S704).

The contents displayed at this time on the salesperson terminal 120 are essentially the same as the questionnaire screen 802. The salesperson on the salesperson terminal 120 replies to the questionnaire by choosing arbitrary one from among the four option buttons of “approval”, “approving partly”, “no reaction” and “disapproval” (S706). The contents of the answer are transmitted to the headquarter system 100 (S709).

In this case, when the salesperson terminal 120 receives the questionnaire in step S704, the message of the arrival of the questionnaire may be displayed on the indicator portion of the initial menu 401. When the salesperson clicks the questionnaire button, the questionnaire control program 103 is provided so that it may answer to the questionnaire.

The headquarter system 100 registers into the questionnaire file 107 the questionnaire created in step S702, after the questionnaire is transmitted to the salesperson terminal 120 in step S703 (S705).

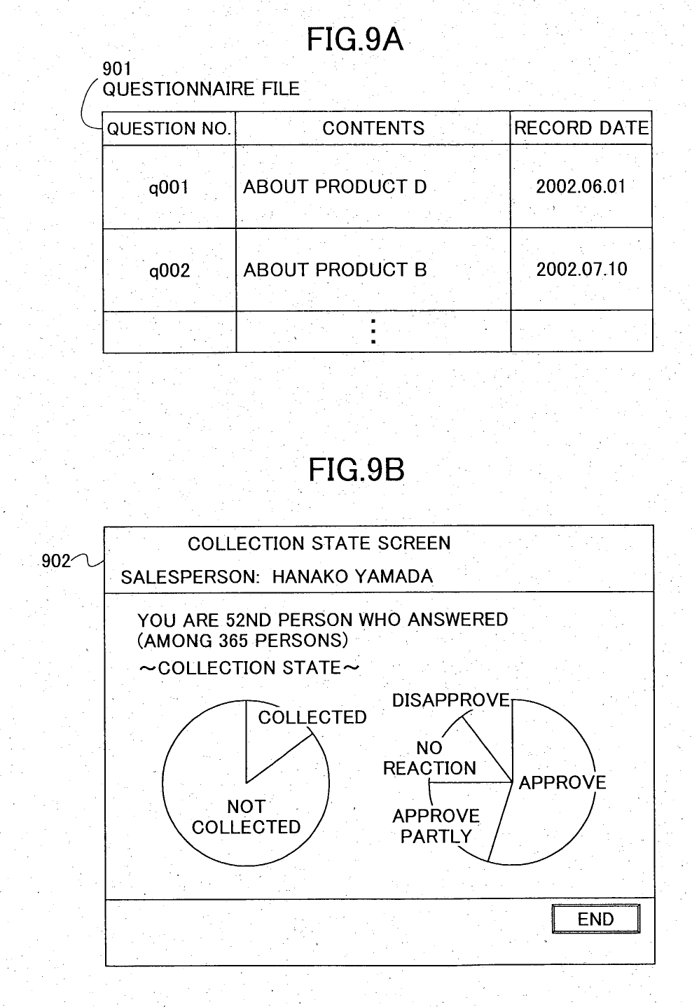

FIG. 9A and FIG. 9B show a questionnaire file and an answer collection state screen respectively. The questionnaire file 901 of FIG. 9A is illustrated as example of the questionnaire file 107.

Each record of the questionnaire file 901 is comprised of the questionnaire number which identifies the recorded questionnaire uniquely, the contents which are the contents of the questionnaire, and the recording date which shows the date of recording of the questionnaire.

When the questionnaire is recorded in step S705, the questionnaire control program 103 performs queuing of the answer from the salesperson terminal 120 about the recording issue concerned, which follows.

The questionnaire control program 103 determines whether a predetermined time has passed (S707) since the transmission of the questionnaire. All the salespersons do not answer to the questionnaire. If it waits for the answers from all the salespersons to arrive though all the salespersons answer to the questionnaire, the start of the totaling process will be overdue. Therefore, the present embodiment is configured so that it waits only for a certain fixed time before all the answers arrive, and the answer totaling process is started as soon as the fixed time has elapsed.

The determination of whether the predetermined time has passed is performed by comparing the recording date of the questionnaire file 901 with the system date.

When it is determined in step S707 that the predetermined time has not elapsed, the questionnaire control program 103 determines whether a predetermined collection value is reached (S708). All the salespersons do not answer to the questionnaire. If it waits for the answers from all the salespersons to arrive though all the salespersons answer to the questionnaire, the start of the totaling process will be overdue. Therefore, the present embodiment is configured so that it waits until the predetermined collection value is reached before all the answers arrive, and the answer totaling process is started as soon as the predetermined collection value is reached.

When it is determined in step S708 that the predetermined collection value is not reached, the questionnaire control program 103 determines whether the answer from the salesperson terminal 120 is received (S710).

When the answer from the salesperson terminal 120 is not received at this time, the control of the computer is returned to step S707 and the same processing is repeated.

The received answer will be registered into the answer file 109 when the answer from the salesperson terminal 120 is received at this time (S711).

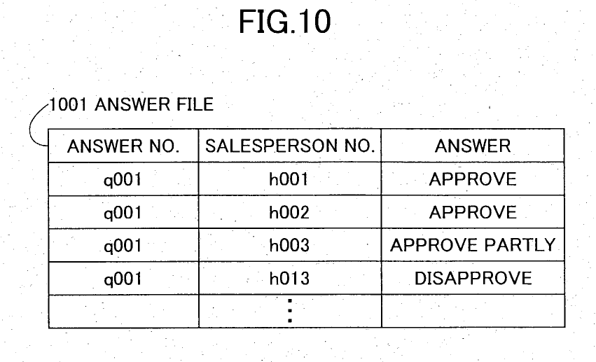

FIG. 10 shows an answer file. The answer file 1001 of FIG. 10 is illustrated as an example of the answer file 109.

Each record of the answer file 1001 is comprised of the answer number which identifies the recorded answer uniquely, the salesperson number which indicates the identification number of the salesperson of concern, and the answer which indicates the answer choice of the salesperson of concern.

Next, the communication control program 101 transmits the provisional collection state of the answers to the terminal 120 of the salesperson whose answer is received in step S710 (S712).

The salesperson terminal 120 receives the collection state transmitted in step S712 (S713). The collection state screen 902 of FIG. 9B is illustrated as an example of the screen in which the collection state at this time is displayed on the salesperson terminal 120. The collection state screen 902 contains the message which indicates what position the answer of the salesperson of concern ranks, which has the effect which promotes the answer of the salesperson and raises answer volition since the salesperson can know the situation immediately after the answer is sent.

The collection state screen 902 includes the graph display of the analysis of the answers to the questionnaire as well as the collection state thereof at this time, and it can also heighten the visual effect.

On the other hand, after the collection state is transmitted to the salesperson terminal 120 in step S712, the control of the headquarter system 100 is transferred to step S707, and the subsequent steps are performed.

When it is determined in step S707 that the predetermined time has passed, or when it is determined in step S708 that the predetermined collection ratio is reached, the questionnaire downloading process of S202 is ended.

The headquarter system 100 performs the answer totaling process to the answer collected in step S202 (S203).

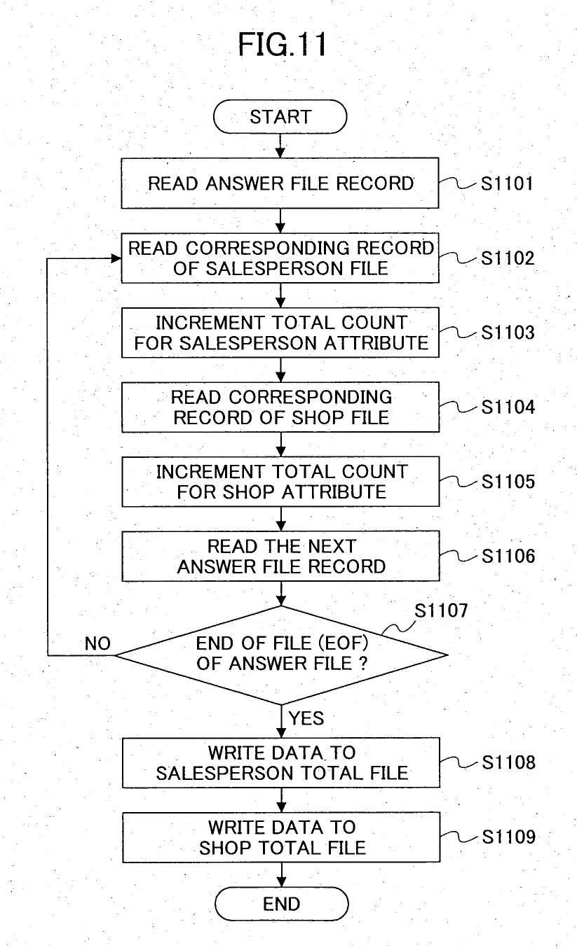

Next, the answer totaling process S203 of FIG. 2 is explained with reference to FIG. 11. FIG. 11 is a flowchart for explaining the answer totaling process S203 executed by the headquarter system of the present embodiment.

The answer totaling program 104 of the headquarter system 100 reads the answer file 109 (S1101).

The answer totaling program 104 searches the salesperson file 106 by using the salesperson number of the read record as the key (S1102).

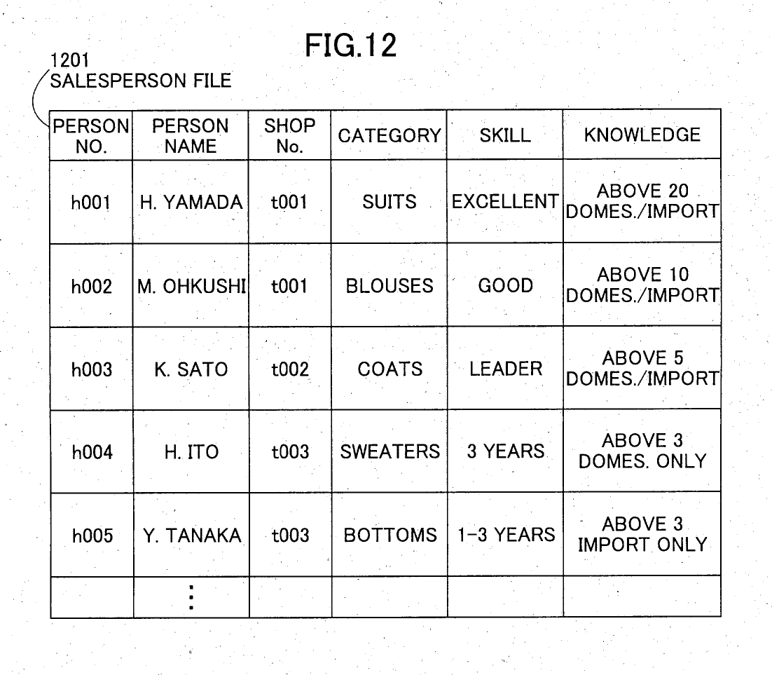

FIG. 12 shows a salesperson file. The salesperson file 1201 of FIG. 12 is illustrated as an example of the salesperson file 106.

The salesperson file 1201 stores the information concerning the salesperson's attribute. Each record of the salesperson file 1201 is comprised of the salesperson number which identifies the salesperson uniquely, the salesperson name, the shop number which indicates the identification number of the shop in which the salesperson works, and the specialty category/skill/knowledge of competition goods which indicate the salesperson's possession skill.

Next, the answer totaling program 104 counts up the total count applicable to the target salesperson's attribute using the answer file record obtained in step S1101 and the salesperson file record obtained in step S1102 (S1103).

This processing totals for every item of the salesperson's attributes (possession skill) rather than only totals the answer.

In order to explain the processing of step S1103 clearly, a description will be given of the case in which the first record of the answer file 1001 of FIG. 10 is read in step S1101.

In this case, the record read in step S1101 includes the answer number: q001, the salesperson number: h001, and the answer: approval.

Next, at step S1102, any record of the salesperson file 1201 is searched for by using the salesperson number: h001 as the key.

The record of the salesperson file 1201 extracted by the searching includes the salesperson number: h001, the salesperson name: Hanako Yamada, the shop number: t001, the category: suits, the skill: excellent class, and the knowledge: above 20 domestic/import companies.

Based on the above-mentioned information, the answer totaling program 104 at step S1103 counts up the applicable parts of the total counts for every attribute of the salesperson.

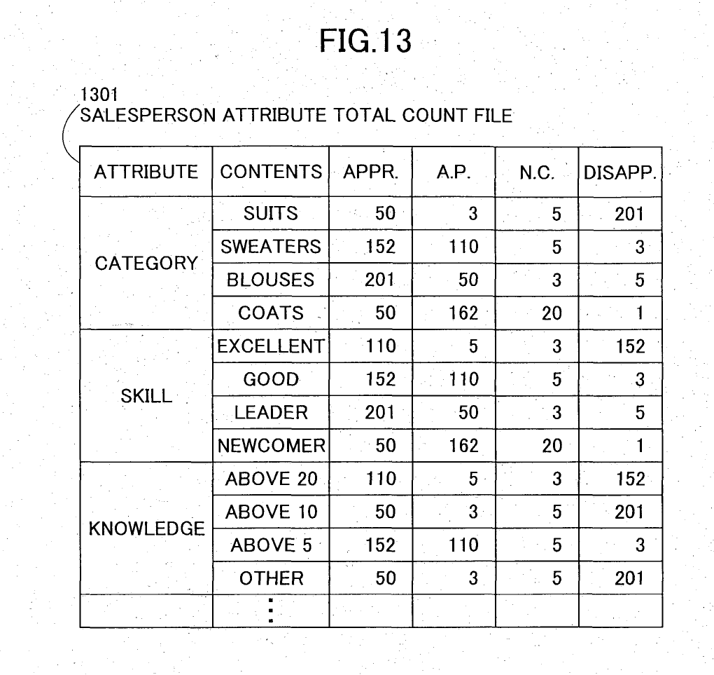

FIG. 13 shows a salesperson attribute total count file. The salesperson attribute total count file 1301 of FIG. 13 is illustrated as an example of the total count file.

The salesperson attribute total count file 1301 is the file temporarily generated in the memory storage (not shown) of the headquarter system 100 during the totaling process.

The salesperson attribute total count file 1301 is used in order to hold the number of the answer choices of each attribute of the salesperson.

In the above-mentioned example, the salesperson's attributes include the category: suits, the skill: excellent class, and the knowledge: above 20 domestic/import companies. The answer of the salesperson is “approval”. Therefore, the answer totaling program 104 at step S1103 increments the total count of each item of “approval” in the salesperson attribute total count file 1301 for the category: suits, the skill: excellent class, and the knowledge: above 20 domestic/import companies, respectively.

Next, the answer totaling program 104 of the headquarter system 100 searches the shop file 108 by using as the key the shop number of the salesperson file record extracted in step S1102 (S1104).

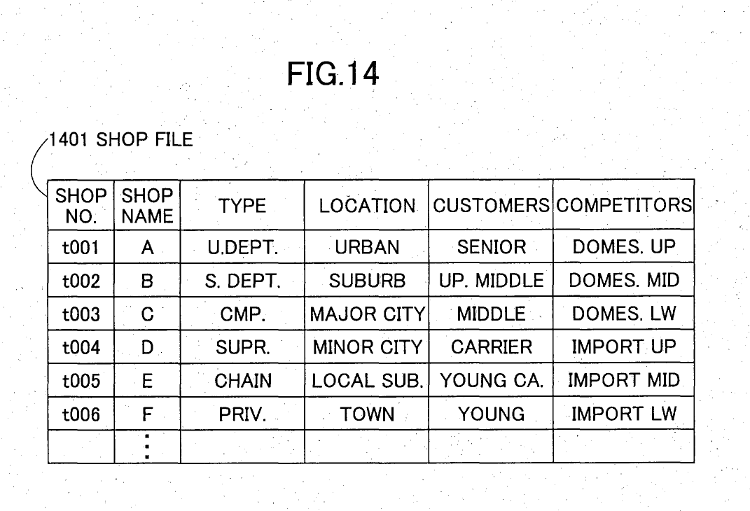

FIG. 14 shows a shop file. The shop file 1401 of FIG. 14 is illustrated as an example of the shop file 108.

The shop file 1401 stores the information concerning the attribute of the shop. Each record of the shop file 1401 is comprised of the shop number which identifies the shop uniquely, the shop name, and the shop type/location/customers/competitors which indicate the attributes of the shop.

The answer totaling program 104 counts up the total count applicable to the attribute of the shop of concern by using the answer file record obtained in step S1101 and the salesperson file record obtained in S1104 (S1105).

This processing totals for every item of the attributes of the shop rather than only totals the answer.

A description will now be given of the processing at the time of reading the first record of the answer file 1001 in step S1101.

In this case, the first record of the salesperson file 1201 is extracted in step S1102 as described above.

The record of the shop file 1401 is searched for by using the shop number: t001 of the extracted first record of the salesperson file 1202 as the key.

The record extracted by the searching includes the shop number: t001, the shop name: department store A, the shop type: urban department store, the location: urban, the customers: senior, and the competitors: domestic upper class.

Based on the above-mentioned information, the answer totaling program 104 at step S1105 counts up the applicable parts of the total counts for every attribute of the shop.

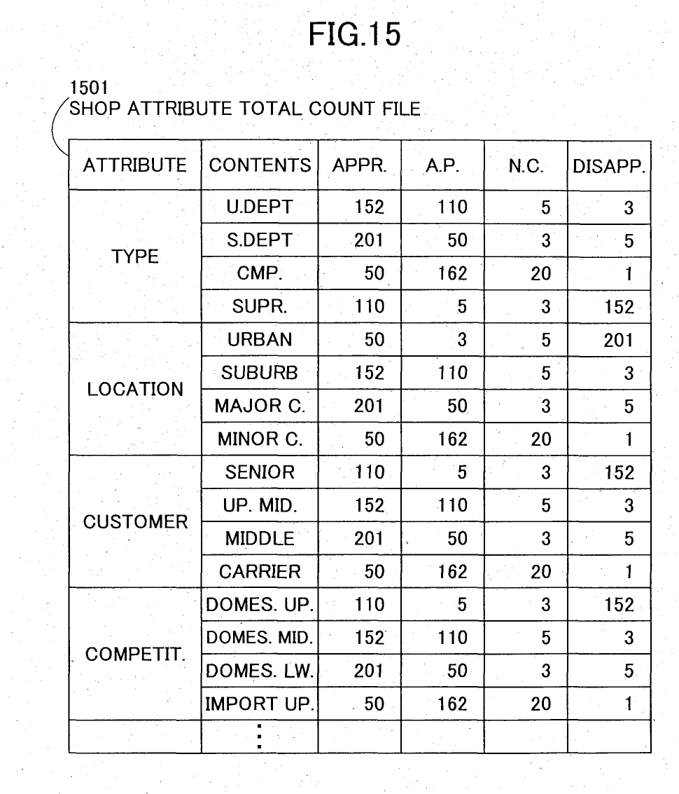

FIG. 15 shows a shop attribute total count file. The shop attribute total count file 1501 of FIG. 15 is illustrated as an example of the total count file.

The shop attribute total count file 1501 is the file temporarily generated in the memory storage (not shown) of the headquarter system 100 during the totaling process.

The shop attribute total count file 1501 is used in order to hold the number of the answer choices of each attribute of the shop.

In the above-mentioned example, the shop attributes include the shop type: urban department store, the location: urban, the customers: senior, and the competitors: domestic upper class. The answer of the salesperson is “approval”. Therefore, the answer totaling program 104 at step S1105 increments the total count of each item of “approval” in the shop attribute total count file 1501 for the shop type: urban department store, the location: urban, the customers: senior, and the competitors: domestic upper class, respectively.

When the processing of step S1105 is completed, the answer totaling program 104 reads the next record of the answer file 109 to obtain the answer of the next salesperson (S1106).

The answer totaling program 104 performs the steps S1102 to S1106 repeatedly until all the records of the answer file 109 are processed (S1107).

When it is determined in step S1107 that the processings for all the records of the answer file 109 are completed, the answer totaling program 104 writes the related information of the salesperson attribute total count file 1301 to the salesperson total file 110 (S1108).

Similarly, the answer totaling program 104 writes the related information of the shop attribute total count file 1501 to the shop total file 110 (S1109).

When the above-described steps are completed, the answer totaling process S203 of FIG. 2 is completed, and all the entire processings for the totaling of the questionnaire concerned are completed.

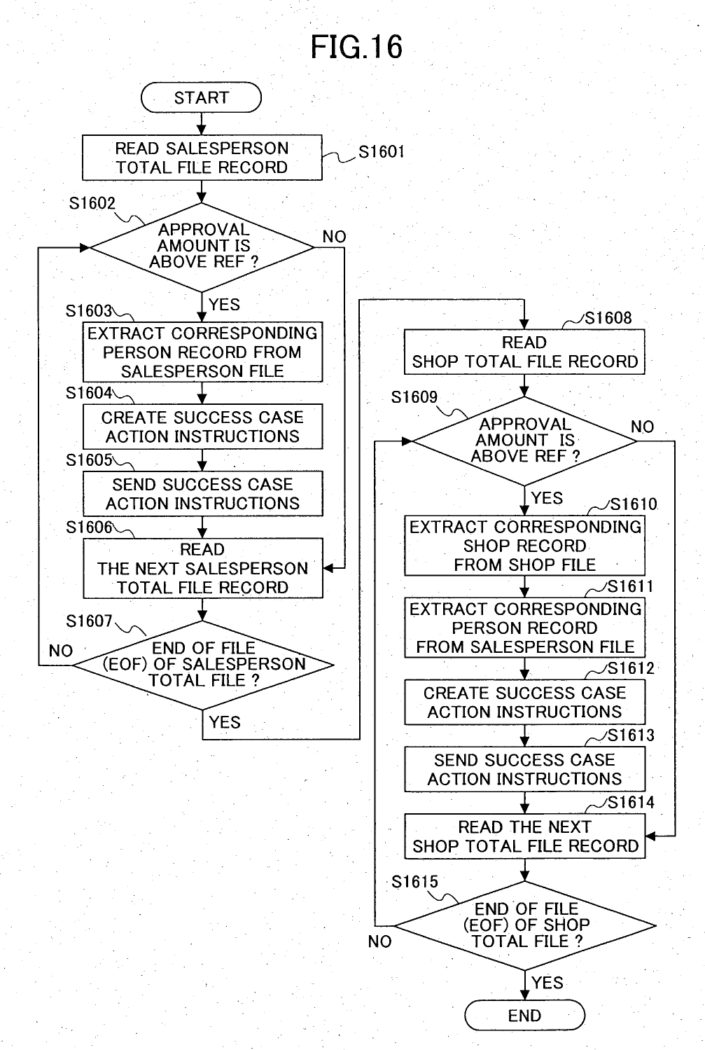

Next, a description will be given of the answer downloading process S204 of FIG. 2 with reference to FIG. 16. FIG. 16 is a flowchart for explaining the answer downloading process S204 executed by the headquarter system of the present embodiment.

The action instructions control program 112 of the headquarter system 100 reads the record of the salesperson total file 110 (S1601).

The action instructions control program 112 determines whether the number of approvals in the read records exceeds a predetermined value (S1602).

In this case, the action instructions control program 112 determines whether the numbers of “approvals” in the read records reaches the predetermined value.

Namely, the action instructions control program 112 determines whether many of the salespersons having the attribute approve to the success case of the questionnaire.

When the number of approvals exceeding the predetermined value is not obtained in the determination of S1602, the action instructions control program 112 reads the next record of the salesperson total file 110 (S1606).

When the number of approvals exceeding the predetermined value is obtained in the determination of S1602, the action instructions control program 112 extracts the record of the corresponding salesperson from the salesperson file 106 (S1603).

At step S1603, the action instructions control program 112 extracts the record of the salesperson, having the salesperson attribute corresponding to the attribute of the salesperson total file 110, from the salesperson file 106.

For example, if the attribute of the record in which the number of approvals exceeding the predetermined value is obtained is related to the category: skin care, the record of “H. Yamada” whose salesperson number is “h001”and whose category is “suits” is extracted from the salesperson file 1201.

Next, the action instructions control program 112 generates the success case action instructions based on the information on the questionnaire file 107, the salesperson total file 110, and the shop total file 111 (S1604).

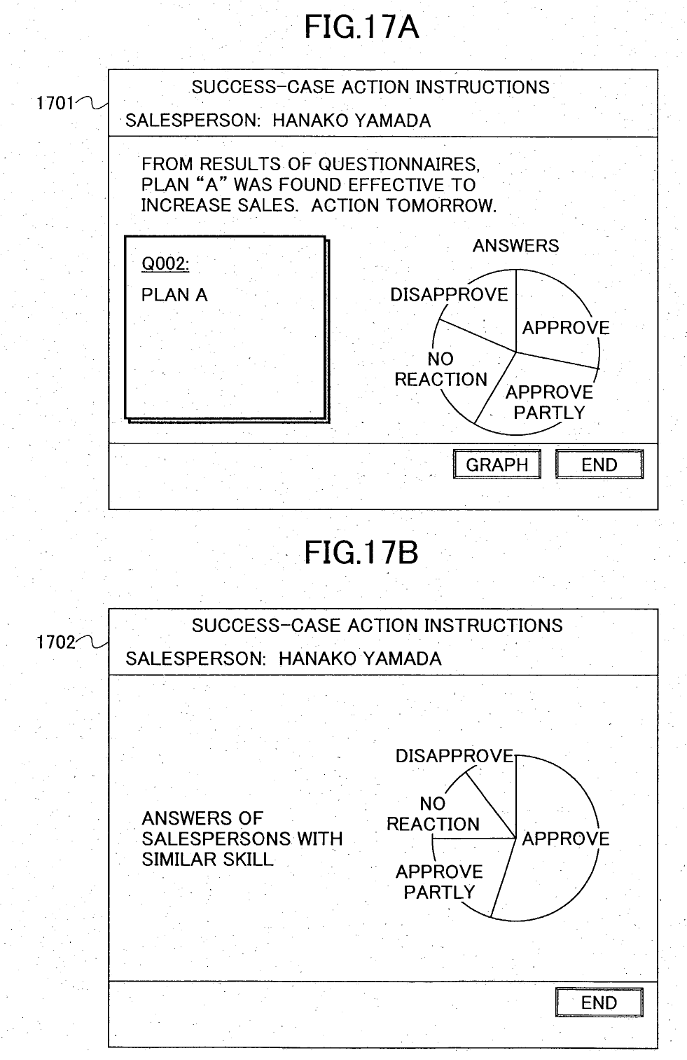

FIG. 17A and FIG. 17B show success-case action instructions screens. An example of the success case action instructions generated in step S1604 is illustrated in the success case action instructions 1701 of FIG. 17A.

The success case is displayed on the body of the success case action instructions 1701. The success case information is copied from the contents of the questionnaire file 107.

Moreover, the total result of the whole answer is expressed as the pie chart. About the total result, it is what showed the ratio of each answer, using respectively the sum total value of each answer of the salesperson total file 110.

In this embodiment, the success case action instructions screen is composed of two pages. When the “graph display” button provided in the footer of the success case action instructions 1701 is clicked, the success case action instructions 1702 of FIG. 17B may be displayed.

The pie chart showing the total result of the answer by the salesperson who is the present processing object, and the salesperson who holds skill of the same grade is displayed on the body of the success case action instructions 1702.

The ratio of each counted value of “approval” of the currently read record of the salesperson total file, specifically “approving partly”, “no reaction”, and “disapproval” is expressed with the pie chart.

The success case action instructions 1701 and 1702 generated as mentioned above are transmitted to the salesperson terminal 120 of the salesperson determined by the currently read record of the salesperson file 106 (S1605).

Thus, the sales support data providing method of this embodiment is configured so that the total results of the answers by the salespersons who hold skill of the same grade are collected, and each related salesperson is provided with the information concerning an optimal selling method. The information transmitted to each related salesperson is not uniform but optimal for the salesperson.

When the success case action instructions 1701 and 1702 transmitted in S1605 are received, the salesperson terminal 120 may display the message of the purport which received sales support information on the indicator of the initial menu 401, and it may constitute it so that the contents may be checked by clicking the “sales support data” button.

When the result of the determination of S1602 is NO, or when processing of S1606 is completed, the action instructions control program 112 reads the next record of the salesperson total file 110 (S1606).

The action instructions control program 112 performs each step from S1602 to S1606 repeatedly until it processes all the records of the salesperson total file 110 (S1607).

When it is determined in step S1607 that the processings for all the records of the salesperson total file 110 are completed, the action instructions control program 112 of the headquarter system 100 reads the record of the shop total file 111 (S1608).

The action instructions control program 112 determines whether the read record obtained the approval beyond the predetermined value (S1609).

In this case, the action instructions control program 112 determines whether the number of “approvals” of the read record exceeds the predetermined value.

Namely, the action instructions control program 112 determines whether many of salespersons who work in the shop of the attribute have approved to the success case of the questionnaire.

When the number of approvals exceeding the predetermined value is not obtained in the determination of S1609, the action instructions control program 112 reads the next record of the shop total file 111 (S1614).

When the number of approvals exceeding the predetermined value is obtained in the determination of S1609, the action instructions control program 112 extracts the record of the corresponding shop from the shop file 108 (S1610).

At step S1610, the action instructions control program 112 extracts the record of the shop, having the shop attribute corresponding to the attribute of the shop total file 111, from the shop file 108.

For example, if the attribute of the record in which the number of approvals exceeding the predetermined value is obtained is related to the shop type: urban department store, the record of “department store A” whose shop type is the “urban department store” and whose shop number is “t001” is extracted from the shop file 1401.

Next, the action instructions control program 112 extracts the record of the salesperson who works in the shop extracted in step S1610, from the salesperson file 106 (S1611).

Specifically, the action instructions control program 112 is provided so that the record whose shop number accords with the shop number of the record extracted in step S1610 is extracted is extracted from the salesperson file 1201.

Next, the action instructions control program 112 generates the success case action instructions based on the information on the questionnaire file 107, the salesperson total file 110, and the shop total file 111 (S1612).

The success case action instructions generated at step S1612 is essentially the same as the success case action instructions 1701 of FIG. 17A.

In the body of the success case action instructions 1701, the comments on the success case are displayed.

The comments of the success case are copied from the contents of the questionnaire file 107.

Moreover, the total result of the whole answers is expressed as the pie chart.

Concerning the total result, it is shown the ratio of each answer choice by using the sum total values of the respective answer choices of the shop total file 111.

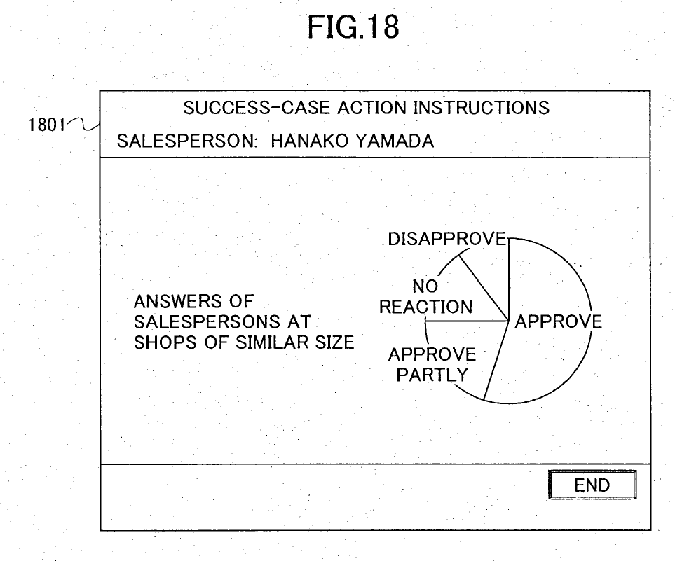

Moreover, the success case action instructions is composed of two pages. When the “graph display” button provided in the footer of the success case action instructions 1701 is clicked, the success case action instructions 1801 of FIG. 18 may be displayed.

The pie chart showing the total result of the answers from the salespersons belonging to the shop used as the present processing object and the shop which holds the attribute of the same grade is displayed in the body of the success case action instructions 1801.

The ratio of each numeric value of the currently read record of the shop total file, specifically “approval”, “approving partly”, “no reaction”, and “disapproval”, is expressed with the pie chart.

The success case action instructions 1701 and 1801 generated as mentioned above are transmitted to the salesperson terminal 120 of the salesperson who works in the shop specified by the currently read shop file 108 (S1613).

Thus, the total results of the answers by the salespersons who work in the shop which holds the attribute of the same grade are transmitted to each related salesperson, and it is possible to provide each related salesperson with the information concerning an optimal selling method for the salesperson.

When the success case action instructions 1701 and 1801 transmitted in step S1613 are received, the salesperson terminal 120 may display the message that the sales support information is received, on the indicator portion of the initial menu 401, and it may be configured so that the contents of the received information may be checked by clicking the “sales support data” button.

When the result of the determination of S1609 is NO, or when the processing of S1613 is completed, the action instructions control program 112 reads the next record of the shop total file 111 (S1614).

Then, the steps S1609 to S1614 are repeatedly performed until all the records of the shop total file 111 are processed (S1615).

When it is determined in step S1615 that the processings for all the records of the shop total file 111 are completed, the answer downloading process S204 of FIG. 2 is completed.

In addition, as for each process of the present invention, it is possible to make it record on a computer-readable storage medium as a program which causes the computer to execute the intended process. The sales support information providing method of the present invention can be realized by using the program stored in the storage medium and causing the computer to execute the providing method.

As computer-readable storage media, there are magnetic-recording equipment, semiconductor memory, etc. For the purpose of distribution in the market, the program may be stored in portable type storage media, such as CD-ROM and floppy disk, and it is also possible to transmit the program in the electronic form to other companies through the network.

Moreover, in the above-described embodiment, the bulletin board in which the salesperson's success case is recorded as the basis of the questionnaire creation is used. Alternatively, the questionnaire may be created based on the information of a sales report that is periodically sent to the headquarter system 100 from the salesperson terminals 120.

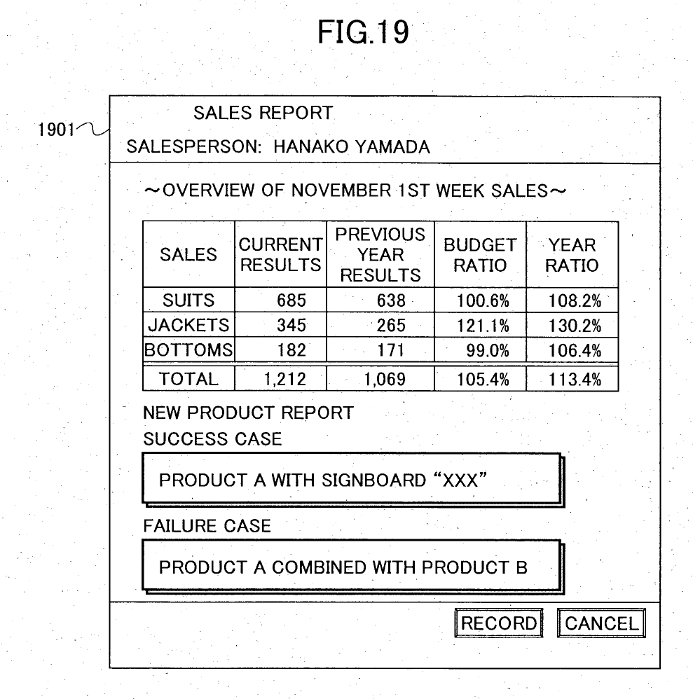

FIG. 19 shows a sales report screen. The sales report screen 1901 in FIG. 19 is illustrated as an example of the sales report.

In the screen of FIG. 19, the example of the success and the example of failure concerning the sales of the new product are indicated with the numeric value which reports the results of business of a certain week.

In this embodiment, the sales report 1901 is periodically transmitted to the headquarter system 100 from the salesperson terminals 120, instead of the bulletin board recording process S201, and the headquarter system 100 registers this sales report information into the file.

In the questionnaire downloading process S202, the operator edits the questionnaire based on the example of the success in the sales report extracted arbitrarily from the recorded sales report information.

Moreover, various other forms of information besides the sales report can be considered. For example, based on “the customer's voice” which the salesperson reports irregularly, it is possible to create the questionnaire.

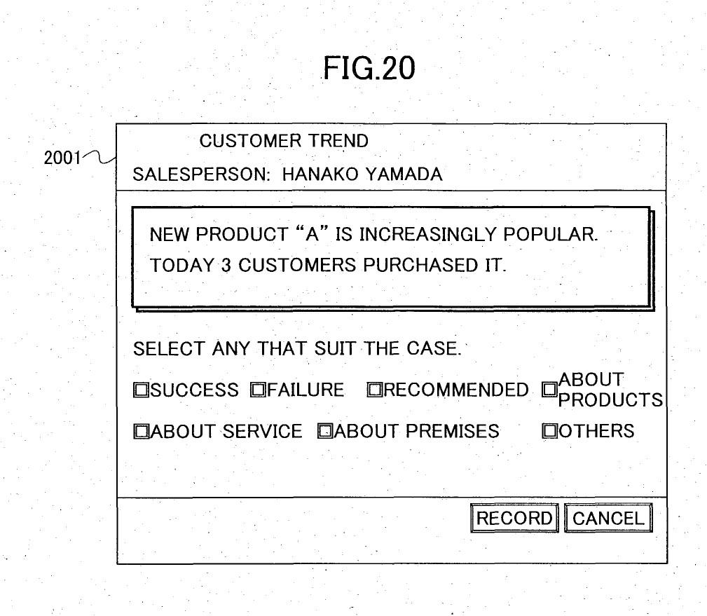

FIG. 20 shows a customer trend screen. The customer trend screen 2001 in FIG. 20 is illustrated as an example of the screen which reports the customer's voice.

In this embodiment, the customer trend screen 2001 is provided as the screen for registering into the headquarter system 100 the information obtained from the customers. The information from the customers is classified into the sales success, the sales failure, the recommendation, the opinion to products, the opinion to service, the opinion to premises, and the others.

In this embodiment, the customer trend information 2001 is irregularly transmitted to the headquarter system 100 from the salesperson terminals 120, instead of the bulletin board recording process S201, and the headquarter system 100 registers this information into the file.

In alternative embodiment, it is possible that the headquarter system 100 at this time registers only the information with the check box of the “sales success” clicked among the other classifications.

In the questionnaire downloading process S202, the operator edits the questionnaire based on the voice of the customer extracted arbitrarily out of the recorded customer's voice information.

As is apparent from the forgoing, not only the bulletin board information but also various other forms of information may be considered as the information which becomes the basis of the questionnaire creation.

As described in the foregoing, according to the sales support information providing method of the present embodiment, it is possible to collect the answer choices of the respective salespersons on the product selling method, and it is possible to provide each related salesperson with the information concerning an optimal selling method for the salesperson.

Moreover, the sales support information providing method of the present embodiment makes it possible to easily carry out the generation and transmission of a questionnaire for collecting the comments of the salespersons since the questionnaire can be created automatically with a selected one of success cases sent from the salespersons to the bulletin board and a set of answer choices.

The present invention is not limited to the above-described embodiments, and variations and modifications may be made without departing from the scope of the present invention.

Further, the present application is based on Japanese priority application No. 2002-210897, filed on Jul. 19, 2002, the entire contents of which are hereby incorporated by reference.

What is claimed is:

1. A sales support information providing method which provides salespersons with information concerning a selling method by using a server, comprising:
transmitting an answer request to salesperson terminals, the answer request requesting each terminal to input an answer choice to the selling method contained in the request;
receiving answer data from the terminals, the answer data of each terminal containing an answer choice input by one of the salespersons for the selling method;
storing the respective answer data corresponding to the salespersons cumulatively as an answer file, the answer file containing records which correspond to the answer data of the salespersons respectively;
extracting each record from the answer file to increment each of total counts for one or more of predetermined attributes which are met by a corresponding one of the salespersons for the extracted record; and
transmitting results of the total counts for said one or more of the predetermined attributes to the salesperson terminals which are related to the selling method.

2. The sales support information providing method according to claim 1 wherein said one or more of the predetermined attributes include shop attributes of shops which the salespersons belong to.

3. The sales support information providing method according to claim 1 wherein said one or more of the predetermined attributes include customer attributes of customers which the salespersons are responsible to.

4. The sales support information providing method according to claim 1 wherein said one or more of the predetermined attributes include salesperson attributes of the salespersons.

5. The sales support information providing method according to claim 1 wherein the answer request contains a questionnaire of the selling method.

6. The sales support information providing method according to claim 5 wherein the questionnaire is generated by including a selected one of success cases, sent from the salespersons to a bulletin board, and a set of answer choices.

7. A computer program embodied therein for causing a computer to execute a sales support information providing method, the method comprising:
transmitting an answer request to salesperson terminals, the answer request requesting each terminal to input an answer choice to a selling method contained in the request;
receiving answer data from the terminals, the answer data of each terminal containing an answer choice input by one of salespersons for the selling method;
storing the respective answer data corresponding to the salespersons cumulatively as an answer file, the answer file containing records which correspond to the answer data of the salespersons respectively;
extracting each record from the answer file to increment each of total counts for one or more of predetermined attributes which are met by a corresponding one of the salespersons for the extracted record; and
transmitting results of the total counts for said one or more of the predetermined attributes to the salesperson terminals which are related to the selling method.

8. A computer-readable storage medium storing a computer program embodied therein for causing a computer to execute a sales support information providing method, the method comprising:
transmitting an answer request to salesperson terminals, the answer request requesting each terminal to input an answer choice to a selling method contained in the request;
receiving answer data from the terminals, the answer data of each terminal containing an answer choice input by one of salespersons for the selling method;
storing the respective answer data corresponding to the salespersons cumulatively as an answer file, the answer file containing records which correspond to the answer date of the salespersons respectively;
extracting each record from the answer file to increment each of total counts for one or more of predetermined attributes which are met by a corresponding one of the salespersons for the extracted record; and
transmitting results of the total counts for said one or more of the predetermined attributes to the salesperson terminals which are related to the selling method.

9. A sales support data providing apparatus comprising:
means for transmitting an answer request to salesperson terminals, the answer request requesting each terminal to input an answer choice to a selling method contained in the request;
means for receiving answer data from the terminals, the answer data of each terminal containing an answer choice input by one of salespersons for the selling method;
means for storing the respective answer data corresponding to the salespersons cumulatively as an answer file, the answer file containing records which correspond to the answer date of the salespersons respectively;
means for extracting each record of the answer file to increment each of total counts for one or more of predetermined attributes which are met by a corresponding one of the salespersons for the extracted record; and
means for transmitting results of the total counts for said one or more of the predetermined attributes to the salesperson terminals which are related to the selling method.
